(19) United States
(12) Patent Application Publication
(10) Pub. No.: US 2017/0116550 A1
(43) Pub. Date: Apr. 27, 2017

(54) SYSTEM AND METHOD FOR ENTERPRISE DATA MANAGEMENT

(71) Applicant: Tata Consultancy Services Limited, Mumbai (IN)

(72) Inventors: Kiran Kumar NUTHETI, Hyderabad (IN); Jayant Sudhakarrao DANI, Mumbai (IN)

(73) Assignee: Tata Consultancy Services Limited, Mumbai (IN)

(21) Appl. No.: 15/280,297

(22) Filed: Sep. 29, 2016

(30) Foreign Application Priority Data
Sep. 30, 2015 (IN) 3719/MUM/2015

(51) Int. Cl. G06Q 10/06; G06F 17/30

(52) U.S. Cl. CPC G06Q 10/0637; G06F 17/30339

(57) ABSTRACT

A method and a system to enable enterprise data management are disclosed. The method for enterprise data management consists of extracting discriminative terms from enterprise policies comprising enterprise level rules and data management goals. Further, one or more data management services and operational unit information are identified corresponding to the discriminative terms. Each data management service comprises of one or more parameters. Subsequently, conceptual enterprise data elements related to the discriminative terms are derived from a data dictionary corresponding to the enterprise policies. Furthermore, a multi-level mapping of the parameters and the operational unit information with one or more corresponding resource databases is performed. The plurality of resource databases comprises of work-items, execution information, geographical area and work-item data associated with each of the work-items. Finally, the data management services are executed on the plurality of resources databases based on the mapping of the parameters and the operational unit information.

### PRIORITY CLAIM

This U.S. patent application claims priority under 35 U.S.C. §119 to: India Application No. 3719/MUM/2015, filed on Sep. 30, 2015. The entire contents of the aforementioned application are incorporated herein by reference.

### TECHNICAL FIELD

The embodiments herein generally relate to enterprise data management, and, more particularly, to a method and system for enterprise policy based enterprise data management.

### BACKGROUND

Enterprise data management includes management of enterprise-wide data with respect to quality, storage, privacy, security, availability, metadata, and so on. Extent of demand and expected level of adherence in an enterprise data management largely varies with the exact data set concerned and stakeholders utilizing said data. Enterprise data management includes substantial in-person dependency in percolating the data requirements and expectations from business users to data architects, to data stewards, to data analysts till an information technology (IT) implementation team. An in-person dependency in enterprise data management can be attributed to the fact that there is a lack of understanding of the expectations and need of data stakeholders at the IT implementation level. For instance, business users may know what policies and rules need to be implemented at enterprise level/business unit level but may not be aware of what data services will enable those policies. Similarly, IT implementation team may know what services can be run on the data, how and what output can be expected but they are not aware of the enterprise needs.

### SUMMARY

Embodiments of the present disclosure present technological improvements as solutions to one or more of the above-mentioned technical problems recognized by the inventors in conventional systems. For example, in one embodiment, a computer implemented method for enterprise data management is provided. The method can be executed by a computing device. The method includes extracting, at the computing device, one or more discriminative terms from one or more enterprise policies comprising enterprise level rules and data management goals. Further, the method includes identifying one or more data management services and operational unit information corresponding to the one or more discriminative terms extracted from the one or more enterprise policies. Each data management services comprise one or more parameters. Subsequently, the method includes deriving conceptual enterprise data elements related to the one or more discriminative terms from a data dictionary corresponding to the one or more enterprise policies. Furthermore, the method includes performing a multi-level mapping of the one or more parameters and the operational unit information with one or more corresponding resource databases of a plurality of resource databases. The plurality of resource databases comprises a plurality of work-items, an execution information, a geographical area and a work-item data associated with each of the plurality of work-items. Finally, the method includes executing the one or more data management services on the plurality of resources databases based on the mapping of the one or more parameters and the operational unit information.

In another embodiment, a computer-implemented system for enterprise data management is provided. The system includes one or more memories, and one or more hardware processors. The one or more memories store instructions and a plurality of resources databases. The one or more memories are coupled to the one or more hardware processors, such that the one or more hardware processors are configured by said instructions stored in the one or more memories to perform extraction of one or more discriminative terms from one or more enterprise policies comprising enterprise level rules and data management goals. Further, the one or more hardware processors are configured by said instructions to identify one or more data management services and operational unit information corresponding to the one or more discriminative terms extracted from the one or more enterprise policies. Each data management services comprise one or more parameters. The one or more hardware processors are further configured by said instructions to derive conceptual enterprise data elements related to the one or more discriminative terms from a data dictionary corresponding to the one or more enterprise policies. Furthermore, the one or more hardware processors are configured by said instructions to perform a multi-level mapping of the one or more parameters and the operational unit information with one or more corresponding resource databases of a plurality of resource databases. The plurality of resource databases comprising a plurality of work-items, an execution information, a geographical area and a work-item data associated with each of the plurality of work-items. The one or more hardware processors are further configured by said instructions to execute the one or more data management services on the plurality of resources databases based on the mapping of the one or more parameters and the operational unit information.

In yet another embodiment, a non-transitory computer-readable medium having embodied thereon a computer program for executing a method for enterprise data management is provided. The method includes, performing, at the computing device, one or more discriminative terms from one or more enterprise policies comprising enterprise level rules and data management goals. Further, the method includes identifying one or more data management services and operational unit information corresponding to the one or more discriminative terms extracted from the one or more enterprise policies. Each data management services comprise one or more parameters. Subsequently, the method includes deriving conceptual enterprise data elements related to the one or more discriminative terms from a data dictionary corresponding to the one or more enterprise policies. Furthermore, the method includes performing a multi-level mapping of the one or more parameters and the operational unit information with one or more corresponding resource databases of a plurality of resource databases. The plurality of resource databases comprising a plurality of work-items, an execution information, a geographical area and a work-item data associated with each of the plurality of work-items. Finally, the method includes executing the one or more data management services on the plurality of resources databases based on the mapping of the one or more parameters and the operational unit information.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this disclosure, illustrate exemplary embodiments and, together with the description, serve to explain the disclosed principles.

FIG.1 illustrates a network implementation for business policy driven enterprise management, in accordance with an example embodiment;

FIG. 2 illustrates a block diagram of a system for enterprise data management, in accordance with an example embodiment;

FIG. 3 illustrates a process flow of a method for enterprise data management, in accordance with an embodiment;

FIG. 4 illustrates a process flow for multi-level mapping of data components in accordance with an example embodiment;

FIG. 5 illustrates examples of the discriminative terms, conceptual data elements and columns in the resources databases, in accordance with an example embodiment;

FIGS. 6A and 6B illustrate an example embodiment of various combinations of having an owner for a resource database table or service ownership;

FIG. 7 illustrates a table depicting example of various data components for enterprise data management, in accordance with an example embodiment; and

FIG. 8 illustrates an example representation of a policy being translated and digitized, in accordance with an embodiment.

### DETAILED DESCRIPTION

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The disclosed embodiments address the gap in understanding of data policies, data process and services related to enterprise data management and point to right and consistent data components across all levels of data management. Previously, the compliance of an enterprise policy was done manually. Herein, various embodiments enables digitization of process for interconnecting various stakeholders in data management with appropriate taxonomy at multiple levels to provide standardized and uniform understanding of data to reduce the risk of person dependency.

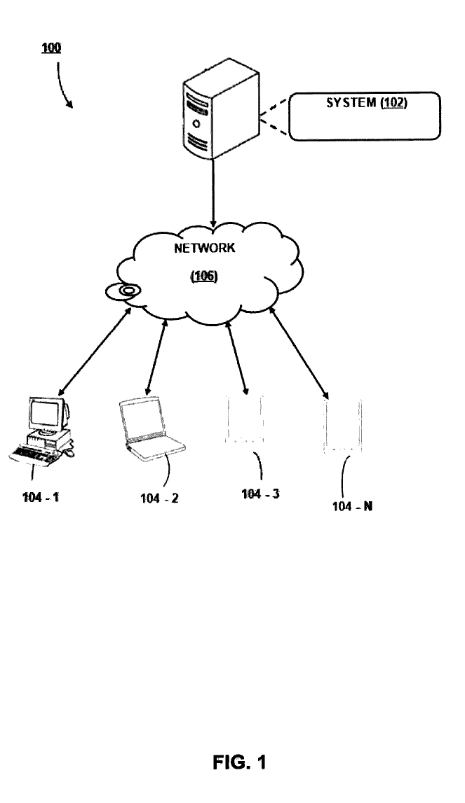

The embodiments herein provide a system and method to enable enterprise policy driven enterprise data management. For example, the disclosed system enables business users to define data policies at enterprise level for data quality, privacy, archival or any other data service. Referring now to the drawings, and more particularly to FIGS. 1 through 8, where similar reference characters denote corresponding features consistently throughout the figures, there are shown preferred embodiments and these embodiments are described in the context of the following exemplary system and/or method.

FIG. 1 illustrates a network implementation 100 for enterprise policy driven enterprise data management, in accordance with an embodiment of the present subject matter. The network implementation. 100 is shown to include a system 102, user devices such as user devices 104-1, 104-2 . . . 104-N, and a communication network 106 for facilitating communication between the system 102 and the user devices 104-1, 104-2 . . . 104-N. In one embodiment, the system 102 facilitates common platform for policy driven enterprise data management. Although the present subject matter is explained considering that the system 102 is implemented as a software application on a server, it may be understood that the system 102 may also be implemented as a variety of computing systems, such as a laptop computer, a desktop computer, a notebook, a workstation, a mainframe computer, a network server, a tablet, a mobile phone, a robot and the like. In one implementation, the system 102 may be implemented in a cloud-based environment. It will be understood that the system 102 may be accessed by multiple users through the one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. Herein multiple users may include business users, data architects, data stewards, data analysts, IT implementation team, and so on.

In one implementation, the communication network 106 may be a wireless network, a wired network or a combination thereof. The communication network 106 can be implemented as one of the different types of networks, such as intranet, local area network (LAN), wide area network (WAN), the Internet, and the like. The communication network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

The system 102 may enable business users to define data policies at enterprise level for data quality, privacy, archival or any other data service. The system 102 facilitates in percolating the data policy to appropriate data components with appropriate machine understandable rules by utilizing data stewards. Additionally, the system 102 may also facilitate in prompting the analysts with appropriate actions to be taken, and upon execution of said actions, the system 102 may provide information to business users with the compliance of the policy.

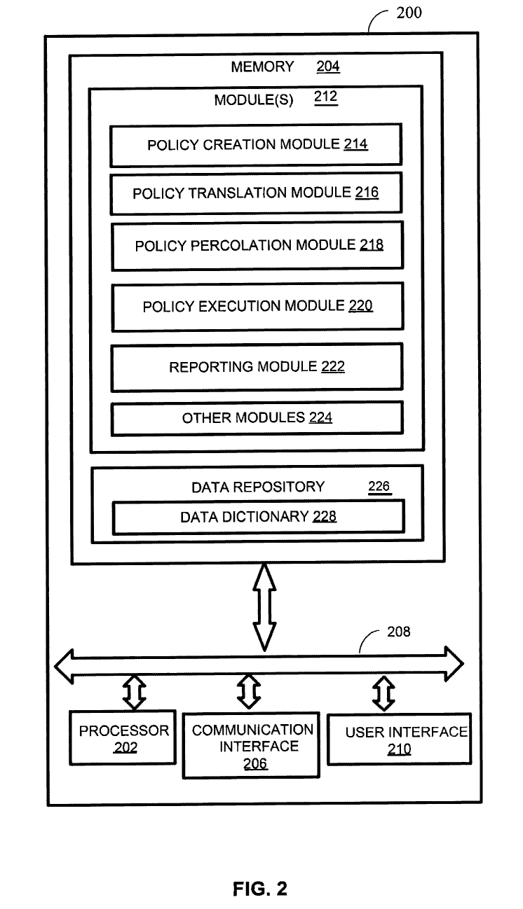

FIG. 2 illustrates a block diagram of a system 200 for enterprise data management, in accordance with an embodiment of the present disclosure. In an embodiment, the system 200 may be embodied or executed in a computing device, for instance the computing device 102 (FIG. 1). The system 200 includes or is otherwise in communication with one or more hardware processors such as a processor 202, one or more memories such as a memory 204, a communication interface 206 and a user interface 210. The processor 202, memory 204, the communication interface 206 and the user interface 210 may be coupled by a system bus such as a system bus 208 or a similar mechanism. Various components of the system 200, along with functionalities thereof are explained below.

In an embodiment, the processor 202 includes circuitry implementing, among others, audio and logic functions associated with the communication. For example, the processor 202 may include, but is not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. The processor 202 may include, among other things, a clock, an arithmetic logic unit (ALU) and logic gates configured to support operation of the processor 202. Further, the processor 202 may include functionality to execute one or more software programs, which may be stored in the memory 204 or otherwise accessible to the processor 202.

The one or more memory such as a memory 204, may store any number of pieces of information, and data, used by the system to implement the functions of the system 200. The memory 204 may include for example, volatile memory and/or non-volatile memory. Examples of volatile memory may include, but are not limited to volatile random access memory (RAM). The non-volatile memory may additionally or alternatively comprise an electrically erasable programmable read only memory (EEPROM), flash memory, hard drive, or the like. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the call control server to carry out various functions in accordance with various example embodiments. Additionally or alternatively, the memory 204 may be configured to store instructions which when executed by the processor 202 causes the system 200 to behave in a manner as described in various embodiments.

The memory 204 also includes module(s) 212 and a data repository 226. The module(s) 212 include, for example, a policy creation module 214, a policy translation module 216, a policy percolation 218, a policy execution module 220, a reporting module 222 and other module(s) 224. The other module(s) 224 may include programs or coded instructions that supplement applications or functions performed by the data pre-processing system 200. The data repository 226 includes enterprise glossary/discriminative terms, data dictionary and the like. Further, the data repository 226 amongst other things, serves as a repository for storing data that is processed, received, or generated as a result of the execution of one or more modules in the module(s) 212.

Although the data repository 226 is shown internal to enterprise data management system 200, it will be noted that, in alternate embodiments, the data repository 226 can also be implemented external to the enterprise data management system 200, where the data repository 226 may be stored within a database communicatively coupled to the enterprise data management system 200. The data contained within such external database may be periodically updated. For example, new data may be added into the database and/or existing data may be modified and/or non-useful data may be deleted from the database. In one example, the data may be stored in an external system. In another embodiment, the data stored in the data repository 226 may be distributed between the enterprise data management system 200 and the external database.

The communication interface 206 is configured to facilitate communication between the network 106 and the system 200. The communication interface 206 may be in form of a wireless connection or a wired connection. Examples of wireless communication interface 206 may include, but are not limited to, IEEE 802.11 (Wifi), BLUETOOTH®, or a wide-area wireless connection. Example of wired communication interface 206 includes, but is not limited to Ethernet.

In an example embodiment, a user interface 210 may b e in communication with the processor 202. Examples of the user interface 210 include but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 210 may include, among other devices or elements, any or all of a speaker, a microphone, a display, and a keyboard, touch screen, or the like. The user interface 210 is utilized to display reports and data generated with respect to compliance of a policy at the enterprise level.

In an embodiment, a set of instructions are used in the processing of functionalities of the system 200. The set of instructions may be in the form of a program or software. The software may be in the form of system software or application software. The enterprise data management system 200, may be facilitated through a computer implemented application available over a network such as the Internet.

In an example embodiment, the processor 202 is configured to, with the content of the memory 204, and optionally with other components described herein, to cause the system 200 to perform enterprise data management. The system 200 is caused to interconnect all stake holders in enterprise data management with appropriate taxonomy at all levels to provide standardized and uniform understanding of data to reduce the risk of person dependency. In particular, the system 200 is caused to enable users to define data policies at enterprise level for data quality, privacy, archival or any other data service. The system 200 is further caused to enable percolation of enterprise policies to appropriate data components with appropriate machine understandable rules. The system 200 may further be caused to digitize policy at physical component level and execute data management services. The system 200 is further caused to consolidate results at physical, conceptual and enterprise levels and provide various compliance reports.

The policy creation module 214 in the system 200 enables a user to define an enterprise policy which has to be implemented at an enterprise level. The user is enabled to select a preconfigured enterprise policy for implementation from a list of enterprise policies. The preconfigured policy has pre-build policy details. Based on the selected enterprise policy, the policy creation module 214 extracts one or more discriminative terms. The discriminative terms may include business glossary terms on which the enterprise policy has to be implemented. Alternatively, in a manual mode the user can manually enter the enterprise policy and select the discriminative terms for execution by the system 200. If the manual mode is selected, appropriate data stewards are notified to perform relevant actions.

In an example embodiment, the user can select the enterprise policy “Policy for know your customer (KYC)” from a list of enterprise policies. Based on the selection, the policy creation module 214 extracts various discriminative terms such as, but not limited to customer portfolio, top line, margin and the like for implementation. In the manual mode the user can define the policy like: “all business units should have complete, accurate and latest contact information of all active customers and exposed as per bank privacy rules”. Further, the user can select ‘Customer Portfolio’ as the discriminative term.

The policy translator module 216 identifies one or more data management services and operational unit information based on the discriminative terms extracted by the policy creation module 214 and the enterprise policy. For example, the various types of operational units may include, but not limited to savings, credit card, loans and the like. The policy translator module 216 performs parsing of the enterprise policy text and based on modified string distance search identifies the data management services. For example, the data management services may include services such as, but not limited to, profiling, masking, cleansing and so on. The data management services include one or more execution parameters. The following Table 1 illustrates an example embodiment for discriminative terms, data management services and execution parameters. The enterprise policy, geography, operational unit, discriminative terms, data management services and execution parameters are collectively referred to as data components.

TABLE 1
Example for discriminative terms, data management services and execution parameters,

| | DISCRIMINATIVE | DATA MANAGEMENT | EXECUTION |
|---|---|---|---|
| | TERMS | SERVICES | PARAMETERS |
| 1 | Accurate | Data Cleansing | |
| 2 | Available | Profiling | Null value analysis |
| 3 | Valid | Profiling | Valid Value analysis |
| 4 | Complete | Profiling | Pattern analysis |
| 5 | Privacy Rules | Masking | |

The policy translator module 216 may embody a model for identification of data management services with respect to key criterion like domain, industry, policy and the like, based on the discriminative terms and the selected enterprise policy. The data management services and the execution parameters are collectively known as data services information. Further, the policy translator module 216, also determine one or more conceptual data elements based on the discriminative terms from a data dictionary.

The following algorithm may be utilized for identification of data management services in an example embodiment.

Algorithm 1:

```
i= Geography (APAC, USA, Europe, Nordic, India and the like)
j= Domain (Banking, Manufacturing, Insurance, Retail)
K= Policy (KYC, Basel Committee on Banking Supervision (BCBS) 239, General data
Protection Regulation (GDPR), Manual)
m= Discriminative Terms (customer Portfolio, Top Line, Margin and the like)
X = (If K = Manual then
        if Key Term = Available then X = Profiling - Null value analysis,
        if Key Term = Valid then X = Profiling - Valid Value analysis,
        if Key Term = Complete then X = Profiling - Pattern analysis
        if Key Term = Privacy then X = Rules Masking
    Else X = Preconfigured Policy)
if (i= USA, j= Banking, K = KYC, m = [BG Tems], x = Preconfigured Policy)
    {
  prepare-serviceorchestrator (i, j , k, m, x,DataElementList, ServicesAndParameters)
        {
          ! ...For each BG Term..! DataElementList = Scan DE-Master
          if DataElement doesn't exist - create and then map
        }
    }
Else (i=USA, j= Banking, K = Manual, m = [BG Terms], x= [Key term1, Key Term2 ...]
  prepare-serviceorchestrator (i, j , k, x, DataElementList, ServicesAndParameters)
        {
          For (a=1, a++, Key Term)
              {
                Scan Services for Key term attach service and parameters
              }
          ! ...For each BG Term..! DataElementList = Scan DE-Master
          if DataElement doesn't exist - create and then map
        }
```

The system 200 includes a service orchestrator which performs a call function. The service orchestrator is present in the data repository 226. The data services information/data components and the conceptual data elements are loaded into the service orchestrator. The service orchestrator passes information related to the data management services and the execution parameters to the policy percolation module 218.

In an alternate embodiment, in the manual mode, the system 200 may send information on the enterprise policy to one or more data stewards of the selected operational units. The data steward is a translation expert to understand the enterprise policies and digitize the enterprise policies for further processing by the system 200. The data stewards can identify the required data management services and execution parameters for implementation of the enterprise policy. The data stewards may further select the appropriate conceptual data elements from the data dictionary based on the discriminative terms on which the data management services are to be executed.

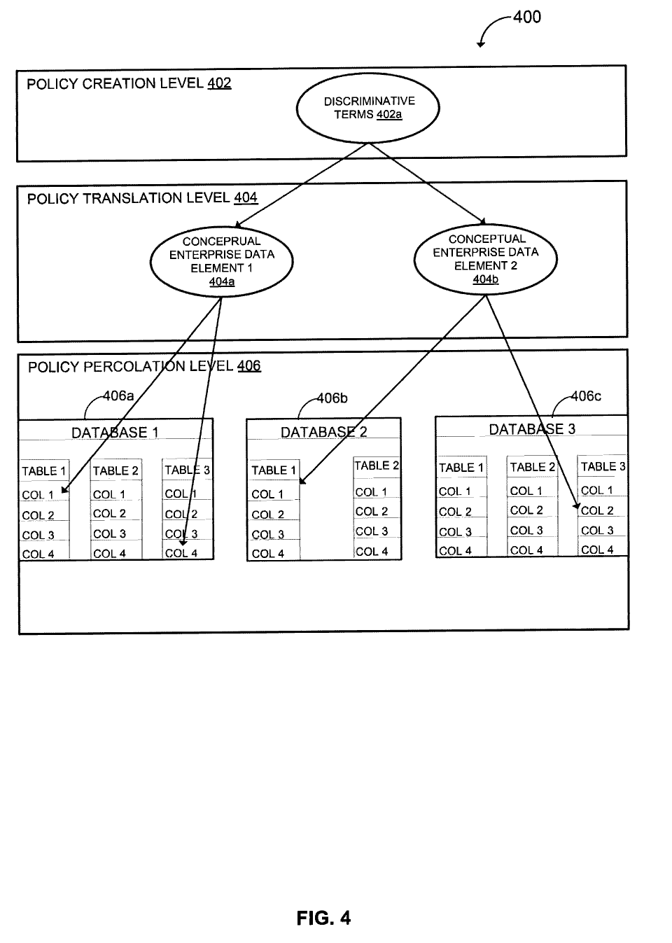

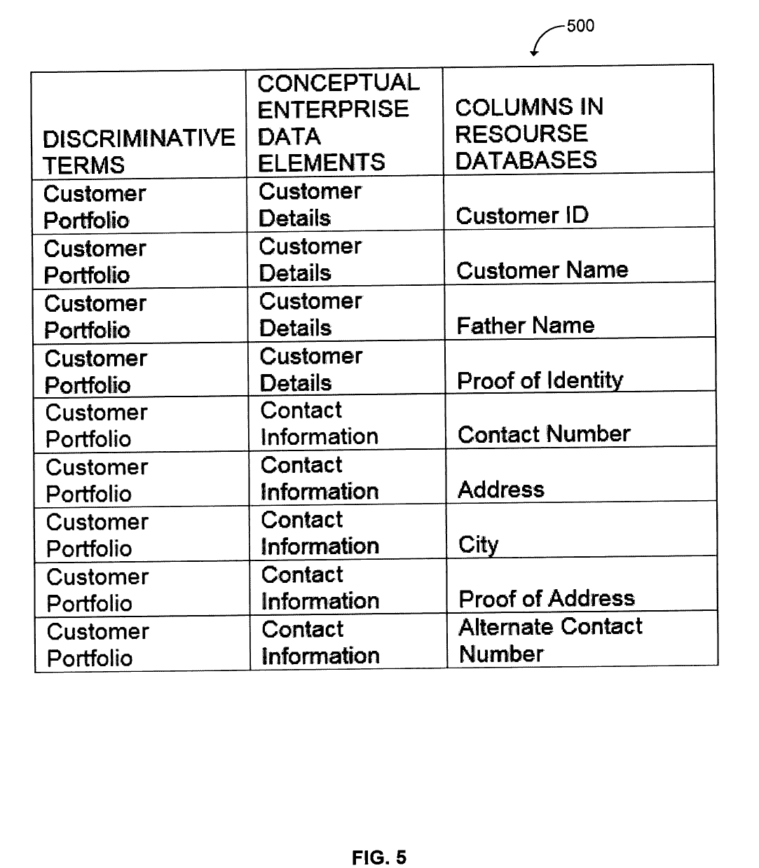

The policy percolator module 218, receives the data services information along with the conceptual data elements from the service orchestrator. The policy percolator module 218 performs a multi-level mapping of the one or more execution parameters the conceptual data elements and the operational unit information with one or more corresponding resource databases of a plurality of resource databases utilizing various predefined rules. The multi-level mapping is further described in detail with reference to FIGS. 4 and 5. The details of the mapped columns of the corresponding resource databases are loaded onto the service orchestrator for each data management service. The service orchestrator passes the above mentioned information to the policy execution module 220.

The policy execution module 220 executes one or more process jobs based on the service orchestrator inputs like columns selected of the resources database, data management service to be executed, execution parameters and the like. After completion of execution of the data management services, the results are stored in a results table with a policy identification number (ID) and completion status is updated. The reporting module 222, consolidates all the results and a compliance report is generated which is displayed by the user interface 210 to the user.

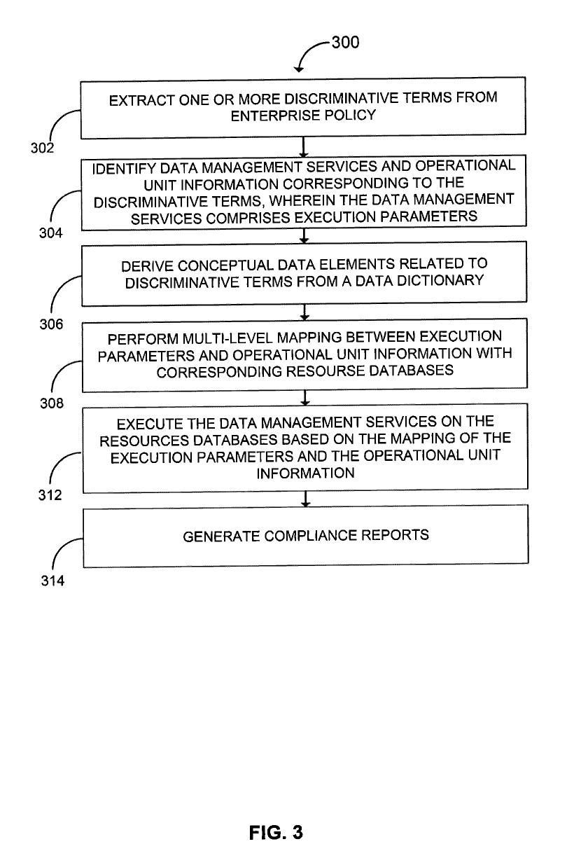

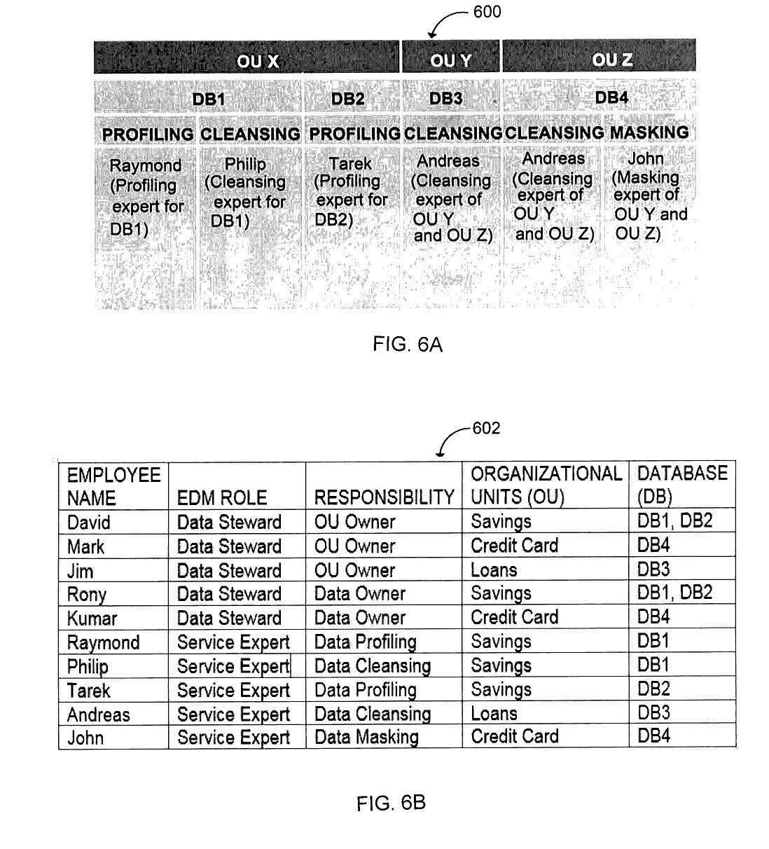

In an alternate embodiment, respective data steward is identified by the system 200 utilizing a combination of resource database, operational unit and data management service. Information related to the mapped columns of the corresponding resource databases and data services information is provided by the service orchestrator to the responsible data steward with the details of columns of the resource databases, process and rules to be performed for implementation of the enterprise policy. This is further explained in detail with reference to FIG. 6. The data stewards may be notified with the details of the data management services to be executed based on ownership for a particular operational unit, resource database and data management service to be executed. After the execution of data management services by the data stewards, the results may be consolidated and a compliance report is generated by the reporting module 222 which may be displayed at the user interface. The process flow of enterprise data management is further explained in detail with reference to FIG. 3.

FIG. 3 illustrates a process flow of a method 300 for enterprise data management, in accordance with an example embodiment. In an embodiment, the method 300 for enterprise data management, can be implemented at a system, for example, the system 200 (FIG. 2).

At step 302 of method 300, the one or more discriminative terms are extracted via one or more hardware processors, by the policy creation module 214 (FIG. 2) from the enterprise policy either selected by the user or defined by the user. The enterprise policy includes enterprise level rules and data management goals. For example, in an enterprise policy of “Know your customer” (KYC) in a bank may include the enterprise level rule such as “contact information of all active customers should be complete and accurate as per bank privacy rules”. The discriminative term for the enterprise policy KYC may include “customer portfolio”.

At step 304, one or more data management services and operational unit information are identified corresponding to the discriminative terms extracted from the one or more enterprise policies by the policy translation module 216 (FIG. 2). Each of the data management services comprises one or more execution parameters. For example, the discriminative term “customer portfolio” may include the data management services such as profiling, masking, cleansing and the like for operational units such as savings, credit cards and so on.

At step 306, the conceptual enterprise data elements related to the discriminative terms is derived from a data dictionary corresponding to the enterprise policy by the policy translation module 216 (FIG. 2). For example, the discriminative term “customer portfolio” may include the data management services such as profiling and conceptual data elements such as customer details, customer contact information and the like. The service orchestrator present in the system 200 is loaded with the details of the data components and the conceptual enterprise data elements. The service orchestrator provides the above mentioned details to the policy percolation module 218 (FIG. 2) for further processing.

At step 308, a multi-level mapping is performed for the execution parameters and the operati,onal unit information with one or more corresponding resource databases of a plurality of resource databases stored in the memory 204 (FIG. 2) by the policy percolation module 218 (FIG. 2) based on the input received from the service orchestrator. The resource databases consist of a plurality of work-items, an execution information, a geographical area and a work-item data associated with each of the plurality of work-items. For example, a resource database for the conceptual data element “customer details” may include “India” as the geography, “customer ID” as a work item and an execution information like “customer IT) to be unique”. Further, the work item data is the alpha numeric data associated with the customer ID in the present example. The details of the resource databases mapped are also saved in the service orchestrator.

At step 310, the data management services are executed on the resources databases based on the mapping of the execution parameters and the operational unit information by the policy execution modules 220 (FIG. 2) and the input received from the service orchestrator. For example, profiling of the customer ID is carried out by performing null analysis by the execution module.

At step 312, a compliance report for the enterprise policy is generated by the reporting module 222 (FIG. 2) which depicts all the results of execution of all the data management services. The compliance report is displayed to the user depicting the implementation of the enterprise policy. The details of multi-level mapping are further illustrated in FIG. 4.

FIG. 4. illustrates a process flow for multi-level mapping of data components in accordance with an example embodiment. The mapping of data components such as discriminative terms to conceptual enterprise data elements facilitates in creating a framework of data landscape across enterprise. The mapping forms the backbone for integrated enterprise data management. The mapping of data components within different levels of the enterprise data management system is illustrated in FIG. 4. The enterprise data management system is shown to include three levels, namely a policy creation level 402, a policy translation level 404 and a policy percolation level 406. The policy creation level 402 may contain discriminative terms 402a which are translated at the policy translation level 404 into conceptual enterprise data element 404a and conceptual enterprise data element 404b. The policy percolation level 406 contains resource database tables 406a, 406b and 406c. The terms database and resource database are used interchangeably throughout the description. At the policy percolation level 406, the conceptual enterprise data element 404a is mapped to the database table 406a containing the particular conceptual enterprise data element 404a and the conceptual enterprise data element 404b is mapped to the database table 406b and the database table 406c containing the particular conceptual enterprise data element 404b.

Each database table as illustrated in FIG. 4 contains conceptual enterprise data elements corresponding to the discriminative terms arranged in physical columns. Further, examples of the discriminative terms, conceptual data elements and the columns in the resources databases are depicted in FIG. 5.

FIG. 5 illustrates examples of the discriminative terms, conceptual data elements and columns in the resources databases, in accordance with an example embodiment. Table 500 illustrates the relationship between the discriminative terms, conceptual data elements and the columns in the resources databases collectively known as data components.

In an alternate embodiment, in the manual mode a resource database table has an owner/steward attached in each of the operational units, this is known as data stewardship. This information will give reference to whom the data service has to be assigned to in each of the operational units. Each operational unit based on the size/complexity/affordability has designated resources who are skillful in executing the data management services, this process is known as service ownership.

FIG. 6A illustrates an example embodiment of various combinations of an owner to a resource database table or service ownership. An owner of a resource database table is responsible for carrying out various data management services like profiling, masking, cleansing and the like. The combinations of service ownership are illustrated in a table. For example, three operational units (OU) have been illustrated as OUx, OUy and OUz. OUx contains two database tables DB1 and DB2, OUy contains database table DB3 and OUz contains database table DB4. Each of the databases may have one or more owners that may be responsible for executing various tasks associated with respective database. For example, owners of DB1 (such as Raymond and Philip) may be responsible for profiling and cleansing respectively whereas, Tarek who is the owner of DB2 may be responsible for profiling under OUx. In OUy, Andreas is the owner of DB3, and may be responsible for cleansing and in OUz Andreas and John are the owners of DB4, and are responsible for cleansing and masking, respectively. It will be understood that a single individual (Andreas in the present embodiment) can be the owner of multiple database tables (DB3 and DB4).

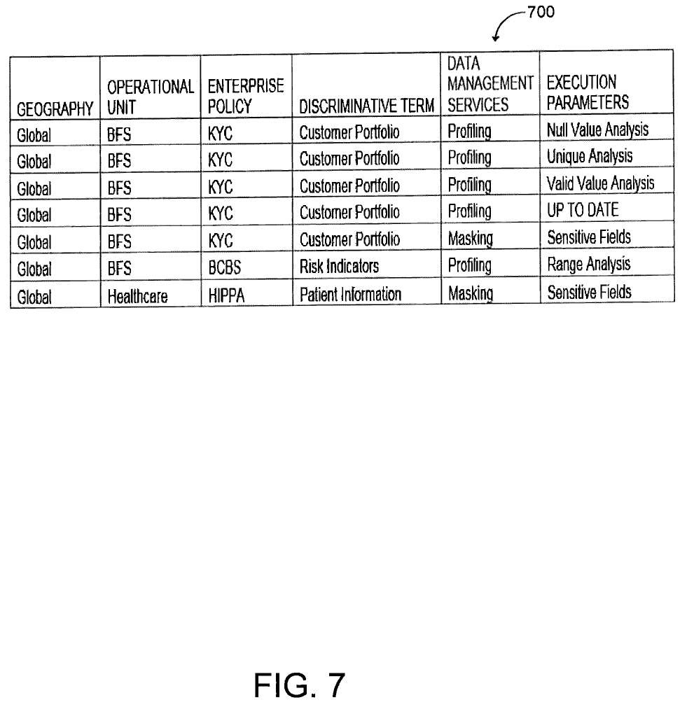

Further, FIG. 6B illustrates a table 602 depicting examples of service ownership. In the table 602 it is depicted that David has the role of data steward and is the OU owner for the OU savings of the resources databases DB1 and DB2. Similarly, Raymond has the role of data management service expert or service expert and is responsible for data profiling for the OU savings of the resources database DB1. Various illustrations of data components are further depicted in FIG. 7.

FIG. 7 illustrates a table 700 depicting example of various data components, in accordance with an example embodiment. For example, the table 700 depicts that geography “global” is mapped to operational unit banking and financial services (BPS) with enterprise policy of “KYC”. Further, the enterprise policy of KYC includes discriminative term as “customer portfolio”, data management service such as “profiling” and execution parameters such as “null value analysis”. There may be a plurality of execution parameters for a single data management service. For example, the data management service “profiling” may include execution parameters such as null value analysis, unique analysis, valid value analysis, range analysis and the like.

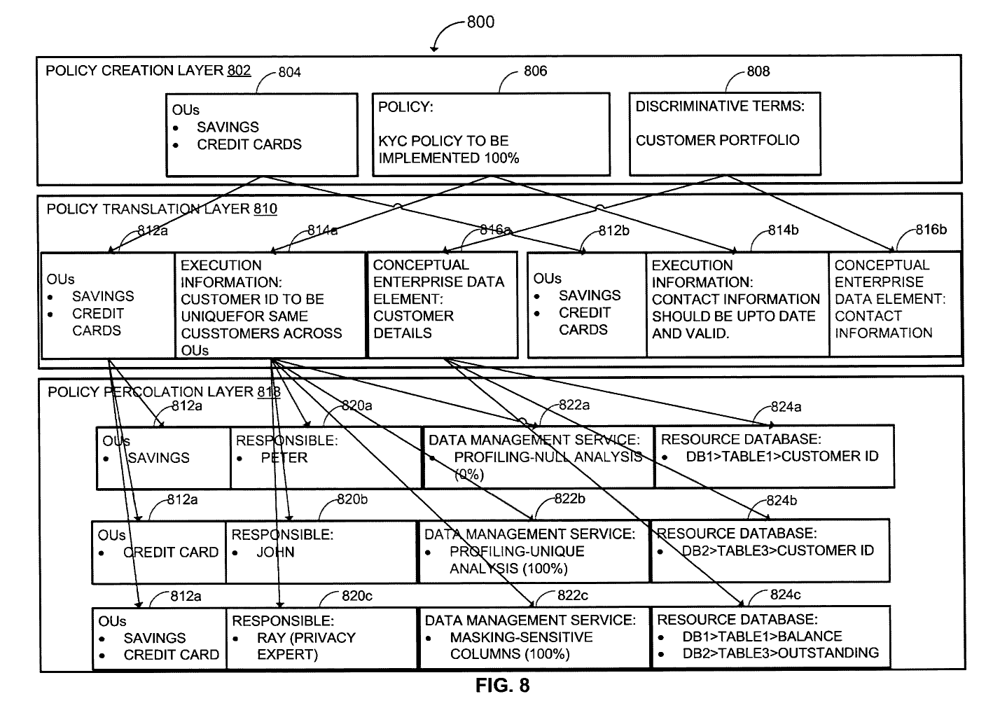

An example case study representing the method for enterprise data management is further described with reference to FIG. 8. In the present example, the policy driven enterprise data management is explained using a bank's know your customer (KYC) policy.

As illustrated in FIG. 8 the policy based enterprise data management may contain three levels, namely a policy creation level (for example the policy creation level 402 of FIG. 4), a policy translation level (for example, the policy translation level 404 of FIG. 4) and a policy percolation level (for example, policy percolation level 406 of FIG. 4). The policy creation level 402 includes operational units (OUs) 512 and enterprise policy 514 discriminative terms 516. In the present embodiment, the OUs 512 consists of two operational units which are savings and credit cards. Further, the enterprise policy 514 is defined as ‘KYC policy to be implemented 100 percent’ and the discriminative term 516 is defined as ‘customer portfolio’ in the given embodiment. The enterprise policy 514 is translated into data rues, in the present embodiment ‘KYC policy to be implemented 100 percent’ is translated as ‘Customer ID to be unique’ 524a and ‘contact information should be up to date and valid’ 524b. The discriminative term 516 which is defined as customer portfolio is translated into conceptual data elements which are customer details 526a and contact information 526b. Further, the policy percolation level 406 consists of resource database tables which contain conceptual enterprise data elements for various OUs. In the policy percolation level 406 the conceptual enterprise data elements (customer details 526a and contact information 526b) are mapped to the database tables containing the corresponding conceptual enterprise data elements by the system. Additionally, each database table has a designated owner responsible for carrying out various operations on the conceptual enterprise data elements.

In the present embodiment, for the OU savings 532, owner 534 (Peter, in the present example) is responsible for carrying out profiling 536 of the conceptual enterprise data elements present in the database 538 (DB1, table 1) containing customer ID. Once the process of profiling is completed by owner 534 the results are consolidated and a compliance report is generated. The system allows for an automatic flow of process and data to the owners of particular data components in an operational unit for a data management service. This leads to the formulation of a consolidated result and report generation at an enterprise level.

Various methods and systems for enterprise data management disclosed herein enables integration of various individual capabilities and data management services which are unique with respect to input, execution and output. Enterprise users can define requirements at their own understanding level and get the adherence while the system automates the entire process of policy compliance and operational activities.

The foregoing description of the specific implementations and embodiments will so fully reveal the general nature of the implementations and embodiments herein that others can, by applying current knowledge, readily modify and/or adapt for various applications such specific embodiments without departing front the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The preceding description has been presented with reference to various embodiments. Persons having ordinary skill in the art and technology to which this application pertains will appreciate that alterations and changes in the described structures and methods of operation can be practiced without meaningfully departing from the principle, spirit and scope.

What is claimed is:

1. A method for enterprise data management, the method comprising:
extracting, via one or more hardware processors, one or more discriminative terms from one or more enterprise policies comprising enterprise level rules and data management goals;
identifying, via the one or more hardware processors, one or more data management services and operational unit information corresponding to the one or more discriminative terms extracted from the one or more enterprise policies, each data management services comprising one or more execution parameters;
deriving, via the one or more hardware processors, conceptual enterprise data elements related to the one or more discriminative terms from a data dictionary corresponding to the one or more enterprise policies;
performing, via the one or more hardware processors, a multi-level mapping of the one or more execution parameters and the operational unit information with one or more corresponding resource databases of a plurality of resource databases, the plurality of resource databases comprising a plurality of work-items, an execution information, a geographical area and a work-item data associated with each of the plurality of work-items; and
executing, via the one or more hardware processors, the one or more data management services on the plurality of resources databases based on the mapping of the one or more execution parameters and the operational unit information.

2. The method as claimed in claim 1, method further comprises receiving the one or more enterprise policies to be implemented in an organization.

3. The method as claimed in claim 2, wherein the one or more enterprise policy is selected form a pre-populated list of enterprise policies.

4. The method as claimed in claim 2, wherein the one or more enterprise policy is user defined.

5. The method as claimed in claim 1, the method further comprising
storing one or more results obtained from execution of data management services on the enterprise policy with a policy identification number in a result table based on the execution of the one or more data management services; and
generating a compliance report based on the result table and the weightage.

6. A system for enterprise data management, the method comprising:
one or more hardware processors; and
one or more memories storing instructions and a repository, the repository comprising a plurality of resources databases, the one or more memories coupled to the one or more hardware processors, wherein the one or more hardware processors are configured by said instructions to:
extract, via the one or more hardware processors, one or more discriminative terms from one or more enterprise policies comprising enterprise level rules and data management goals;
identify, via the one or more hardware processors, one or more data management services and operational unit information corresponding to the one or more discriminative terms extracted from the one or more enterprise policies, each data management services comprising one or more execution parameters;
derive, via the one or more hardware processors, conceptual enterprise data elements related to the one or more discriminative terms from a data dictionary corresponding to the one or more enterprise policies;
perform, via the one or more hardware processors, a multi-level mapping of the one or more execution parameters and the operational unit information with one or more corresponding resource databases of a plurality of resource databases, the plurality of resource databases comprising a plurality of work-items, an execution information, a geographical area and a work-item data associated with each of the plurality of work-items; and
execute, via the one or more hardware processors, the one or more data management services on the plurality of resources databases based on the mapping of the one or more execution parameters and the operational unit information.

7. The system as claimed in claim 6, wherein the one or more hardware processors are further configured by the instructions to receive the one or more enterprise policies to be implemented in an enterprise.

8. The system as claimed in claim 7, wherein the one or more hardware processors are further configured by the instructions to select the one or more enterprise policy from a pre-populated list of enterprise policies.

9. The system as claimed in claim 7, wherein the one or more enterprise policy is user defined.

10. The system as claimed in claim 6, the one or more hardware processors are further configured by the instructions to:
store one or more results from execution of data management services on the enterprise policy with a policy identification number in a result table based on the execution of the one or more data management services; and
generate a compliance report based on the result table and the weight.

11. A non-transitory computer-readable medium having embodied thereon a computer program for executing a method comprising:
extracting, via one or more hardware processors, one or more discriminative terms from one or more enterprise policies comprising enterprise level rules and data management goals;
identifying, via the one or more hardware processors, one or more data management services and operational unit information corresponding to the one or more discriminative terms extracted from the one or more enterprise policies, each data management services comprising one or more execution parameters;
deriving, via the one or more hardware processors, conceptual enterprise data elements related to the one or more discriminative terms from a data dictionary corresponding to the one or more enterprise policies;
performing, via the one or more hardware processors, a multi-level mapping of the one or more execution parameters and the operational unit information with one or more corresponding resource databases of a plurality of resource databases, the plurality of resource databases comprising a plurality of work-items, an execution information, a geographical area and a work-item data associated with each of the plurality of work-items; and
executing, via the one or more hardware processors, the one or more data management services on the plurality of resources databases based on the mapping of the one or more execution parameters and the operational unit information.
